(19) United States
(12) Patent Application Publication
(10) Pub. No.: US 2006/0254891 A1
(43) Pub. Date: Nov. 16, 2006

(54) Electric Device Capable Of Increasing Switch Precision

(76) Inventor: Chung-Ping Chuang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/383,491

(22) Filed: May 16, 2006

(30) Foreign Application Priority Data
May 16, 2005 (TW) 094115778

(51) Int. Cl. H01H 13/00

(52) U.S. Cl. 200/296

(57) ABSTRACT

An electric device includes a housing having an opening, a printed circuit board installed in the housing, a switch formed on the printed circuit board for enabling functions of the electric device, a faceplate for coving the opening of the housing, a keypad formed on a position of the faceplate corresponding to the switch for triggering the switch, and a fixing mechanism comprising a first fixing element extending from a side of the faceplate facing the printed circuit board, and a second fixing element extending from the printed circuit board for being combined with the first fixing element.

### BACKGROUND OF THE INVENTION

1. Field of the Invention

The present invention provides an electric device capable of increasing switch precision, and more particularly, an electric device having a fixing mechanism for fixing the distance between a keypad and a switch, so as to increase switch precision.

2. Description of the Prior Art

Generally, when starting or stopping a function of an electric device, a user operates an inner switch of the electric device through a keypad on a faceplate of the electric device. That is, by pressing the keypad on the faceplate, the user indirectly triggers the switch, and activates or stops the function.

For example, please refer to FIG. 1, which illustrates a schematic diagram of a prior art disc drive 100. For simplicity, FIG. 1 shows corresponding positions of a printed circuit board (PCB) 102, a chassis 104, a housing 106, and a faceplate 108 in the disc drive 100. Circuits laid on the PCB 102 perform functions of the disc drive 100, such as disc reading, writing, etc. The PCB 102 is set on the chassis 104. The housing 106 and the faceplate 108 protect inner structures of the disc drive 100, such as the PCB 102, laser devices, etc. The faceplate 108 is fixed on the housing 106 through a hook 113, and is fixed on the chassis 104 through a hook 114. The housing 106 includes a hole 117 corresponding to the hook 113, and the chassis 104 also includes a hole 116 corresponding to the hook 114. Therefore, the combination of the housing 106, the faceplate 108, and the chassis 104 encloses the disc drive 100 completely.

Some functions of the disc drive 100 are enable and disable by triggering of keypads on the faceplate 108, which is convenient for manufacturing and fabricating. Therefore, in FIG. 1, the PCB 102 includes a switch 112, utilized for starting or stopping some operations of the circuits on the PCB 102, such as disc injecting, ejecting, playing, etc. Corresponding to the switch 112, the faceplate 110 includes a keypad 110 for triggering the switch 112. That is, when a user presses the keypad 110, the keypad 110 triggers the switch 112, so as to perform a function. Therefore, there must be a suitable distance between the keypad 110 and the switch 112 such as distance 118 shows in FIG. 1, so as to prevent the keypad 110 from unnecessarily or incorrectly triggering the switch 112. In such case, fabricating the disc drive 100 becomes complicated. The distance between the keypad 110 and the switch 112 should be equal to the distance 118, so the position of the switch 112 on the PCB 102, the position of the PCB 102 on the chassis, and even positions of the housing 106, the faceplate 108, the keypad 110, the hooks 113, 114, and the holes 116, 117 become critical. As a result, it is possible that circuits of the disc drive 100 work well, but the keypad 110 cannot trigger the switch 112 correctly.

For example, if the keypad 110 and the switch 112 are too close such that the keypad 110 presses the switch 112 completely, then the keypad 110 always triggers the switch 112 even though the user does not press the keypad 110. Oppositely, if the keypad 110 and the switch 112 are too far, then the keypad 110 is incapable of triggering the switch 112. Therefore, in the prior art, a lot of viable factors must be considered when fabricating an electric device having a faceplate and keypads, causing an increase in production cost and fabrication difficulty.

### SUMMARY OF THE INVENTION

It is therefore a primary objective of the claimed invention to provide an electric device capable of increasing switch precision.

The present invention discloses an electric device capable of increasing switch precision. The electric device comprises a housing having an opening, a printed circuit board installed in the housing, a switch formed on the printed circuit board for enabling functions of the electric device, a faceplate for coving the opening of the housing, a keypad formed on a position of the faceplate corresponding to the switch for triggering the switch, and a fixing mechanism comprising a first fixing element extending from a side of the faceplate facing the printed circuit board, and a second fixing element extending from the printed circuit board for being combined with the first fixing element.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a prior art disc drive.

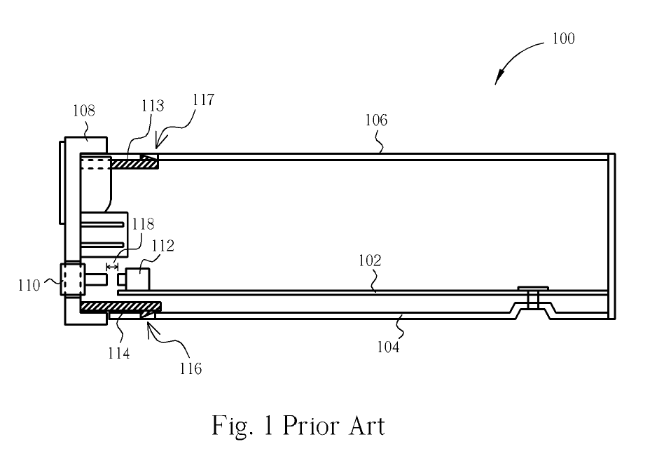

FIG. 2 illustrates a sectional diagram of an electric device capable of increasing switch precision in accordance with the first embodiment of the present invention.

FIG. 3 illustrates a sectional diagram of a disc drive in accordance with the third embodiment of the present invention.

FIG. 4 illustrates a vertical view diagram of a disc drive shown in FIG. 3.

FIG. 5 illustrates a sectional diagram of an electric device capable of increasing switch precision in accordance with the second embodiment of the present invention.

### DETAILED DESCRIPTION

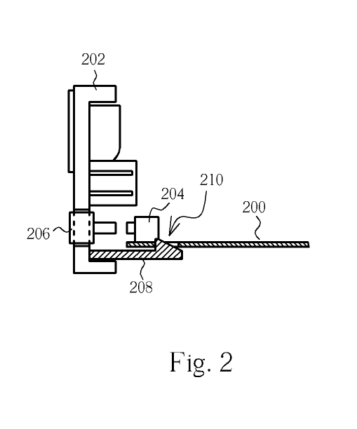

Please refer to FIG. 2, which illustrates a sectional diagram of an electric device capable of increasing switch precision in accordance with the first embodiment of the present invention. For simplicity, FIG. 2 shows corresponding positions of a PCB 200, a faceplate 202, a switch 204, a keypad 206, a hook 208, and a groove 210. Circuits laid on the PCB 200 perform functions of the electric device. The faceplate 202 is set in front of the electric device, utilized for protecting the electric device. The switch 204 is set on the PCB 200 for starting or stopping some functions. The keypad 206 is set on a position of the faceplate 202 corresponding to the switch 204. A user can press the keypad 206 to trigger the switch 204, so as to perform the functions. A combination of the hook 208 and the groove 210 form a fixing mechanism of the present invention, utilized for fixing a distance between the faceplate 202 and the PCB 200. One end of the hook 208 extends from a side of the faceplate 202 facing the PCB 200, while the other end of the hook 208 is a hook structure fastening on the groove 210 of the PCB 200. Therefore, once the hook structure of the hook 208 fastens on the groove 210, the distance between the faceplate 202 and the PCB 200 are fixed. As a result, the only factors affecting the distance between the keypad 206 and the switch 204 are the position of the switch 204 on the PCB 200 and the position of the keypad 206 on the faceplate 202. In short, the hook 208 firms up the distance between the faceplate 202 and the PCB 200 to decrease factors affecting the distance between the keypad 206 and the switch 204, so as to decrease production cost and fabrication difficulty, and increase yield.

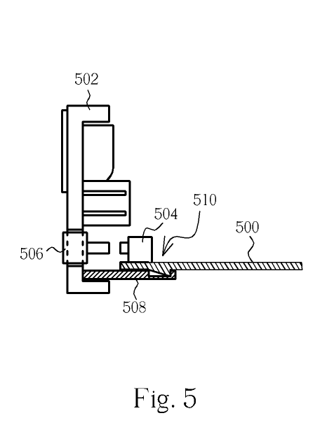

Other than the fixing mechanism of the hook 208 and the groove 210, please refer to FIG. 5, which illustrates a sectional diagram of an electric device capable of increasing switch precision in accordance with the second embodiment of the present invention. For simplicity, FIG. 5 shows corresponding positions of a PCB 500, a faceplate 502, a switch 504, a keypad 506, a bar 508, and a flange 510 in the electric device. Circuits laid on the PCB 500 perform functions of the electric device. The faceplate 502 is set in front of the electric device, utilized for protecting the electric device. The switch 504 is set on the PCB 500 for starting or stopping some functions. The keypad 506 is set on a position of the faceplate 502 corresponding to the switch 504. A user can press the keypad 506 to trigger the switch 504, so as to perform the functions. A combination of the bar 508 and the flange 510 forms a fixing mechanism of the present invention, utilized for fixing a distance between the faceplate 502 and the PCB 500. One end of the bar 508 extends from a side of the faceplate 502 facing the PCB 500, while the other end of the bar 508 is a fillister structure fastening on the flange 510 of the PCB 500. Therefore, once the flange 510 fastens on the fillister of the bar 508, the distance between the faceplate 502 and the PCB 500 are fixed. As a result, the only factors affecting the distance between the keypad 506 and the switch 504 are the position of the switch 504 on the PCB 500 and the position of the keypad 506 on the faceplate 502. In short, the bar 508 firms up the distance between the faceplate 502 and the PCB 500 to decrease factors affecting the distance between the keypad 506 and the switch 504, so as to decrease production cost and fabrication difficulty, and increase yield.

In the prior art, a lot of factors affecting the distance between the keypad and the switch must be considered, so that the keypad may always trigger the switch, or the keypad may not be able to trigger the switch. However, in the present invention, the only factors affecting the distance between the keypad and the switch are the position of the switch on the PCB and the position of the keypad on the faceplate, and in fact, these two factors do not cause any effect as mass manufacturing technologies (opendie and plating for example) develop widely.

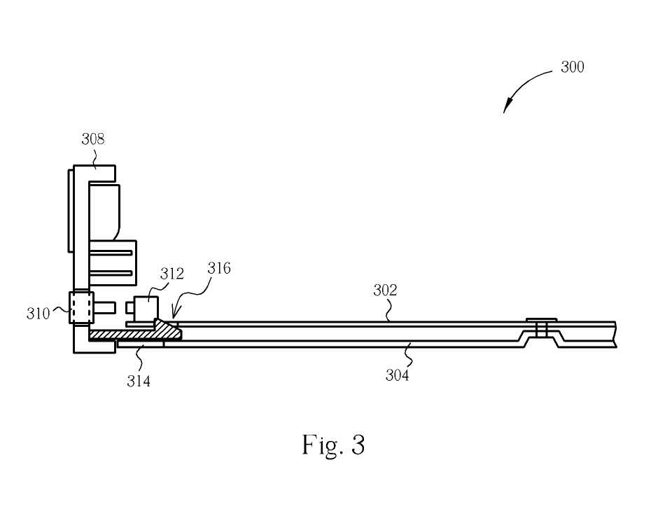

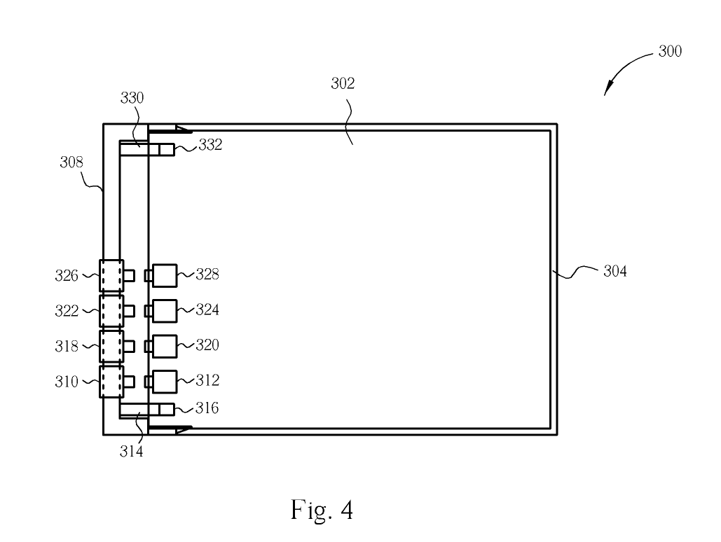

As to an electric device having multiple keypads, maintaining distances between each keypad and a corresponding switch becomes more difficult. The present invention can fix a distance between a faceplate and a PCB in the electric device through a fixing mechanism to decrease factors affecting the distance between the keypads and the corresponding switches. For example, please refer to FIG. 3 and FIG. 4. FIG. 3 illustrates a sectional diagram of a disc drive 300 in accordance with the third embodiment of the present invention, and FIG. 4 illustrates a vertical view diagram of the disc drive 300. In the disc drive 300, a PCB 302 is set on a chassis 304. Circuits laid on the PCB 302 perform functions of the disc drive 300, such as disc reading, writing, etc. The faceplate 308 is set in front of the disc drive 300, and includes keypads 310, 318, 322, and 326 corresponding switches 312, 320, 324, and 328 of the PCB 302. The switches 312, 320, 324, and 328 are utilized for starting or stopping some functions of the disc drive 300, such as disc injecting, ejecting, fast-forwarding, rewinding, playing, etc. The hooks 314, 330 and the grooves 316, 322 are formed according to the fixing mechanism shown in FIG. 2. One end of each of the hooks 314 and 330 extends from the faceplate 308, while the other end of each of the hooks 314 and 330 is a hook structure fastening on one of the grooves 316 and 322 on the PCB 302. The hooks 314 and 330 can firm up the distance between the faceplate 308 and the PCB 302, and the faceplate 308 is also fixed on a housing (not shown in FIG. 3 and FIG. 4) of the disc drive 300 through other hooks. Therefore, the distance between the faceplate 308 and the PCB 302 can be fixed by the combination of the hooks 314, 330, and the grooves 316, 322. As a result, factors affecting distances between the keypads 310, 318, 322, 326 and the switches 312, 320, 324, 328 can be decreased, so as to decrease production cost, increase yield, and simplify the enclosing procedure.

In the present invention, elements of the fixing mechanism are exemplified for fixing the distance between the faceplate and the PCB. Various modifications could be made without departing from the spirit of the present invention. Moreover, electric devices having keypads on faceplates for triggering switches on PCBs, such as disc drives, display devices, etc., can adopt the present invention. In summary, the present invention firms up the distance between the faceplate and the PCB to decrease factors affecting the distance between the keypad and the switch, so as to decrease production cost and fabrication difficulty, and increase yield.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electric device comprising:
a housing having an opening;
a printed circuit board installed in the housing;
a switch formed on the printed circuit board for enabling functions of the electric device;
a faceplate for coving the opening of the housing;
a keypad formed on a position of the faceplate corresponding to the switch for triggering the switch; and
a fixing mechanism comprising a first fixing element extending from a side of the faceplate facing the printed circuit board, and the printed circuit board comprising a second fixing element for being combined with the first fixing element.

2. The electric device of claim 1, wherein the fixing mechanism makes a distance between the faceplate and the printed circuit board equal to a first value.

3. The electric device of claim 1, wherein a distance between the keypad and the switch is equal to a second value.

4. The electric device of claim 1, wherein the first fixing element comprises a groove.

5. The electric device of claim 4, wherein the second fixing element comprises a flange corresponding to the groove.

6. The electric device of claim 1, wherein the first fixing element comprises a flange.

7. The electric device of claim 6, wherein the second fixing element comprises a groove corresponding to the flange.

8. The electric device of claim 1 further comprising a plurality of hooks extending from the faceplate.

9. The electric device of claim 1 being a disc drive.

10. The electric device of claim 1 being a display device.
